(19) United States
(12) Patent Application Publication
(10) Pub. No.: US 2020/0139688 A1
(43) Pub. Date: May 7, 2020

(54) TRIM CUP FORMING A MOTOR-VEHICLE HANDLE RECESS

(71) Applicants: Albert RORING, Gronau-Epe (DE); Rembert Schulze Wehninck, Tutzing (DE)

(72) Inventors: Albert RORING, Gronau-Epe (DE); Rembert Schulze Wehninck, Tutzing (DE)

(21) Appl. No.: 16/672,596

(22) Filed: Nov. 4, 2019

(30) Foreign Application Priority Data
Nov. 6, 2018 (DE) 102018008707.8

(51) Int. Cl. B32B 27/12; B32B 5/02; B32B 27/32; B32B 27/36; B60R 13/04

(52) U.S. Cl. CPC B32B 27/12; B32B 5/024; B32B 5/026; B32B 27/32; B32B 27/36; B32B 2605/08; B32B 2262/0276; B32B 2262/0253; B32B 2260/046; B32B 2260/021; B60R 13/04

(57) ABSTRACT

A trim cup of a latch or access of a door, hatchback, or a fuel cap cover of a motor vehicle forming a handle recess has a manually pivotable cover flap hinged on the outside of the trim cup and connected to a latch for the purpose of opening the door, hatchback, or fuel cap cover. The trim cup and/or the outer edge of the trim cup is provided with reinforcement in the form of a composite material of thermoplastic polypropylene or polyester with at least one textile reinforcing layer with strips, fibers, or yarns of polypropylene, polyester, metal, carbon, or an aramid.

### FIELD OF THE INVENTION

The invention relates to a trim cup of a latch or access hole of a motor-vehicle door, hatchback, or fuel cap cover and forming a handle recess.

### BACKGROUND OF THE INVENTION

In such a trim cup, a manually pivotable cover flap is hinged on the outside of the trim cup and connected to the mechanism of the latch for the purpose of opening the door, the hatchback, or the fuel cap cover.

To open the hatchback of a motor vehicle, it is known to provide a handle recess on which a cover flap is hinged, the cover flap being swung up by hand in order to unlock and open the hatchback. Experience has shown that unauthorized persons will violently destroy the trim cup, particularly by hammer blows, in order to gain access.

### OBJECT OF THE INVENTION

It is the object of the invention to provide a trim cup for a latch of a door, hatchback, or fuel cap cover that is designed such that it is largely unable to be violently broken open.

It is another object of the invention to increase the stability of the components in order to improve and simplify subsequent processes such as welding.

### SUMMARY OF THE INVENTION

These objects are achieved according to the invention in that the trim cup and/or the outer edge of the trim cup is provided with reinforcement in the form of a composite material of thermoplastic polypropylene or polyester with at least one particularly textile reinforcing layer with strips, fibers, or yarns of polypropylene, polyester, metal, carbon, or an aramid.

Such a trim cup has a high level of stability and resistance to external forces such as hammer blows, so that unauthorized opening is substantially more difficult. In addition, such a high-stability trim cup facilitates subsequent processing steps.

It is advantageously proposed that the material of the trim cup and/or of the outer edge of the trim cup is a self-reinforced thermoplastic composite comprising superposed layers of thermoplastic polypropylene, polyester, or aramid. It is also advantageous if layers of homogeneous polypropylene film, copolymer-containing polyolefin film, homogeneous polyester film, or copolymer-containing polyester film alternate with reinforcing layers in which either the polypropylene or the polyester is in the form of a strip, fiber, or yarn, or in which one, two, or more reinforcing layers have polypropylene or polyester strips and/or polypropylene or polyester fibers and/or polypropylene or polyester yarns.

It is especially advantageous if
the strips, fibers, or yarns of polypropylene, polyester, or an aramid in the reinforcing layers form a textile, particularly a woven or knitted fabric,
the strips and/or fibers are arranged randomly in the reinforcing layers, and
the polypropylene or polyester material of the multilayer trim cup has a total thickness of from 0.5 mm to 3 mm.

Furthermore, it is also proposed that the cover flap on an outer face form an emblem and the cover flap is connected to the trim cup by a hinge and has an outwardly pivotal lower portion.

### BRIEF DESCRIPTION OF THE DRAWING

The above and other objects, features, and advantages will become more readily apparent from the following description, reference being made to the accompanying drawing in which:

FIG. 1 is a vertical section through the instant invention; and

FIG. 2 is a large-scale section through a detail of the invention.

### SPECIFIC DESCRIPTION OF THE INVENTION

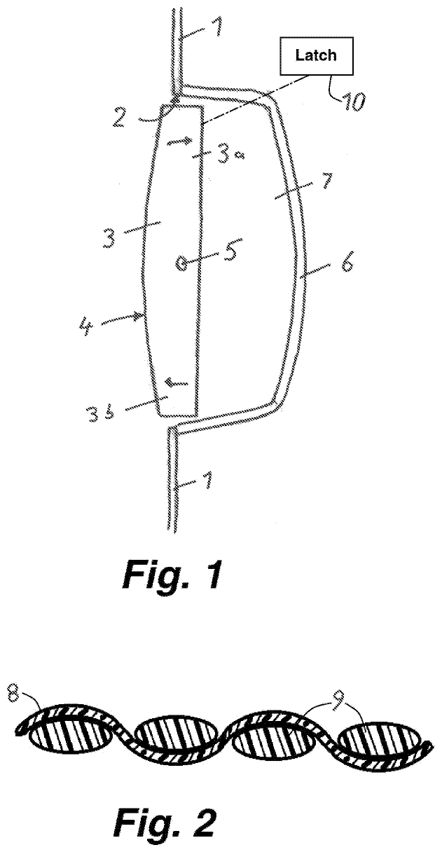

As seen in FIG. 1, a metal sheet 1 of the outer panel of a door, hatchback, or fuel cap cover of a motor vehicle has a particularly circular opening 2 that is filled by a particularly circular cover flap 3 bearing an emblem 4 on an outer face. The cover flap 3 can be pivoted about a central horizontal pivot axle 5 that is fastened directly or indirectly to a trim cup 6 forming on the rear side of the cover flap a handle recess 7 into which an upper portion 3a of the cover flap can pivot. The pivoting-in of the upper portion 3a is effected by applying pressure manually to the upper portion 3a against the spring force of an unillustrated return spring.

When the cover flap 3 pivoted, its lower portion 3b moves outward, making it possible to grasp behind the lower portion by hand in order to raise the hatchback or open the door or the fuel cap cover. The cover flap 3 is mechanically and/or electrically connected to a lock/latch 10 (FIG. 1) of the hatchback, door, or fuel cap cover, so that the hatchback, door, or fuel cap cover is unlocked by lifting the cover flap 3.

The trim cup 6 and/or an outer edge of the trim cup consists of or is reinforced with a composite material as shown in FIG. 2 of thermoplastic polypropylene or polyester with at least one particularly textile reinforcing layer with strips, fibers, or yarns 8 and 9 of polypropylene, polyester, metal, carbon, or an aramid. Preferably, the material of the trim cup and/or of the outer edge of the trim cup is a self-reinforced thermoplastic composite comprising superposed layers of thermoplastic polypropylene, polyester, or aramid, with at least two layers of homogeneous polypropylene film, copolymer-containing polyolefin film, homogeneous polyester film, or copolymer-containing polyester film alternating with at least two reinforcing layers as shown in FIG. 2 in which either the polypropylene or the polyester is in the form of a strip, fiber, or yarn 8 or 9, or in which the at least two reinforcing layers have polypropylene or polyester strips and/or polypropylene or polyester fibers and/or polypropylene or polyester yarns. The strips, fibers, or yarns 8 and 9 of polypropylene, polyester, or an aramid in the reinforcing layers form a textile 8, 9, particularly a woven or knitted fabric. Preferably, the polypropylene or polyester material of the multilayer trim cup 6 has a total thickness of from 1.0 mm to 3 mm.

The strips and/or fibers 8 and 9 can be embedded in the reinforcing layers in the form of a woven or knitted fabric. However, they can also be arranged in an unordered crisscross manner.

We claim:

1. A trim cup of a latch or access of a door, hatchback, or a fuel cap cover of a motor vehicle forming a handle recess, wherein a manually pivotable cover flap is hinged on the outside of the trim cup and is connected to a latch for the purpose of opening the door, hatchback, or fuel cap cover, wherein the trim cup and/or the outer edge of the trim cup is provided with reinforcement in the form of a composite material of thermoplastic polypropylene or polyester with at least one particularly textile reinforcing layer with strips, fibers, or yarns of polypropylene, polyester, metal, carbon, or an aramid.

2. The trim cup according to claim 1, wherein the material of the trim cup and/or of the outer edge of the trim cup is a self-reinforced thermoplastic composite comprising superposed layers of thermoplastic polypropylene, polyester, or aramid.

3. The trim cup according to claim 2, wherein layers of homogeneous polypropylene film, copolymer-containing polyolefin film, homogeneous polyester film, or copolymer-containing polyester film alternate with reinforcing layers in which either the polypropylene or the polyester is in the form of a strip, fiber, or yarn, or in which one, two, or more reinforcing layers have polypropylene or polyester strips and/or polypropylene or polyester fibers and/or polypropylene or polyester yarns.

4. The trim cup according to claim 1, wherein the strips, fibers, or yarns of polypropylene, polyester, or an aramid in the reinforcing layers form a textile, particularly a woven or knitted fabric.

5. The trim cup according to claim 1, wherein the strips and/or fibers in the reinforcing layers are arranged in an unordered crisscross manner.

6. The trim cup according to claim 1, wherein the polypropylene or polyester material of the multilayer trim cup has a total thickness of from 0.5 mm to 3 mm.

7. The trim cup according to claim 1, wherein the cover flap has an emblem on an outer face.

8. The trim cup according to any one of the preceding claims, wherein the cover flap is connected to the trim cup by a hinge and has an outwardly pivotal lower portion.
